(19) United States
(12) Patent Application Publication
(10) Pub. No.: US 2007/0222687 A1
(43) Pub. Date: Sep. 27, 2007

(54) Foldable Wireless Electrical Device

(76) Inventor: Corbett Ray Rowell, Hong Kong (CN)

Correspondence Address: MOLEX INCORPORATED, 2222 WELLINGTON COURT, LISLE, IL, 60532, US

(21) Appl. No.: 10/580,067

(22) PCT Filed: Nov. 19, 2004
(86) PCT No.: PCT/US04/38936

§ 371 Date: May 15, 2007

(30) Foreign Application Priority Data
Nov. 20, 2003 (CN) 200310117913.3

(51) Int. Cl. H01Q 1/24

(52) U.S. Cl. 343/702

(57) ABSTRACT

Foldable wireless electrical device comprises a first portion, a second portion including an antenna portion, and a shaft. The shaft is extended between two adjacent ends of the first portion and the second portion for pivotally connecting the first portion and the second portion, and is linked with the first portion. The shaft forms at least one metal section, so that the metal section electrically couples to the antenna portion when the first portion pivots to a predetermined position with respect to the second portion. In this way, a detuning phenomenon of receiving and transmitting signal of the electrical device in the closed position is improved, thereby improving the receiving and transmitting of signals of the electrical device.

### FIELD OF THE INVENTION

The present invention relates to a foldable wireless electrical device, and more particularly to a foldable wireless electrical device which can improve a detuning phenomenon of receiving and transmitting signals thereof in a closed position.

### BACKGROUND OF THE INVENTION

FIGS. 1 and 2 show a prior art foldable mobile phone (mobile phone for short hereinafter) 1 under opened and closed positions, respectively, and the mobile phone 1 has a first portion 10 and a second portion 11. One end of the first portion 10 forms a base 101, and one end 110 of the second portion 11 faced to the base 101 forms a shaft 111 to pivot to the base 101, for making the second portion 11 pivot between an open position and a closed position with respect to the first portion 10. The first portion 10 includes a first circuit board 13 inside, and the second portion 11 includes a second circuit board 14 inside, and one antenna portion 16 is disposed adjacent to one end 130 of the first circuit board 13 and located below the base 101. The length of the antenna portion 16 is only ¼ wavelength or even shorter due to limitation of volume of the foldable mobile phone 1. Therefore, the type of antenna portion improves its function of receiving and transmitting signals at a low frequency section commonly by depending on the circuit board or a grounding length inside the mobile phone 1.

Referring to FIG. 1, when the mobile phone 1 is in the open position, the first circuit board 13 and the second circuit board 14 are not overlapped with each other. Accordingly, they form a first effective grounding length L_{eff1} to be used as a grounding area for the antenna portion 16. As such, the antenna portion 16 at low frequency may obtain a predetermined function of receiving and transmitting signals. But, referring to FIG. 2, when the mobile phone 1 is in the closed position, because the first circuit board 13 and the second circuit board 14 are overlapped to form a capacitive effect, a second effective electrical length L_{eff2} formed therefrom is shortened to only 30-50% of L_{eff1}, which causes the mobile phone 1 at low frequency to not get the same effect of receiving and transmitting signals as it does in the open position since the grounding area of the antenna portion 16 is reduced. Therefore, as shown in FIG. 3, a detuning phenomenon of receiving and transmitting signals of the mobile phone 1 at low frequency in the open and closed positions is produced to adversely affect the function of receiving and transmitting signals of the mobile phone 1 in the closed position.

### SUMMARY OF THE INVENTION

An object of the present invention is to provide a foldable wireless electrical device which can improve a detuning phenomenon of receiving and transmitting signals thereof under its opened and closed positions.

Additionally, another object of the present invention is to provide a pivotable device for improving a detuning phenomenon of receiving and transmitting signals of a foldable wireless electrical device under opened and closed positions.

To fulfill the above-mentioned objects, the present invention provides for a foldable wireless electrical device which comprises a first portion, a second portion, and a shaft. The second portion includes an antenna portion. The shaft is extended between two adjacent ends of the first portion and the second portion for pivotally connecting the first portion and the second portion, and is linked with the first portion. The shaft forms at least one metal section, so that the metal section electrically couples to the antenna portion when the first portion pivots to a predetermined position with respect to the second portion. By this way, properly increase the length of the antenna portion, improve an effect of receiving and transmitting signal of the electrical device in a predetermined position, thereby improving the detuning phenomenon of receiving and transmitting signal of the electrical device.

Additionally, the present invention provides for a foldable wireless electrical device which comprises a first portion, a second portion, and a shaft. The first portion includes a metal section. The second portion includes an antenna portion. The shaft is extended between two adjacent ends of the first portion and of the second portion for pivotally connecting the first portion and the second portion, and is linked with the first portion. The shaft forms at least one coupling portion to electrically connect to the metal section, so that the metal section electrically couples to the antenna portion by the coupling portion when the first portion pivots to a predetermined position with respect to the second portion. By this way, properly increase the length of the antenna portion, and improve an effect of receiving and transmitting signal of the electrical device in a predetermined position, thereby improving the detuning phenomenon of receiving and transmitting signal of the electrical device.

Furthermore, the present invention provides for a pivotable device which is provided on a foldable wireless electrical device, and is used for pivotally connecting a first portion and a second portion of the electrical device. The pivotable device includes a base, an antenna portion and a shaft. The base is disposed on one end of the second portion. The antenna portion is routed on the base. The shaft is pivotally disposed on the base and is provided for fixing the first portion for pivotally connecting the first portion and the second portion. The shaft forms at least one metal section, so that the metal section electrically couples to the antenna portion when the first portion pivots to a predetermined position with respect to the second portion. By this way, properly increase the length of the antenna portion, and improve an effect of receiving and transmitting signal of the electrical device in a predetermined position, thereby improving the detuning phenomenon of receiving and transmitting signal of the electrical device.

Still furthermore, the present invention provides for a pivotable device which is provided on a foldable wireless electrical device, and is used for pivotally connecting a first portion and a second portion of the electrical device. The first portion includes at least one metal section, and the second portion includes an antenna portion. The pivotable device includes a base, an antenna portion and a shaft. The base is disposed on one end of the second portion and has a coupling portion thereon to electrically connect to the antenna portion. The shaft is pivotally disposed on the base and is provided for fixing the first portion, for pivotally connecting the first portion and the second portion. The shaft forms at least one shaft coupling portion to electrically connect to the metal section, so that the antenna coupling portion electrically couples to the shaft coupling portion when the first portion pivots to a predetermined position with respect to the second portion. By this way, properly increase the length of the antenna portion, and improve an effect of receiving and transmitting signal of the electrical device in a predetermined position, thereby improving the detuning phenomenon of receiving and transmitting signal of the electrical device.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a perspective view of a prior art foldable mobile phone in an opened position;

FIG. 2 is a perspective view of a prior art foldable mobile phone in FIG. 1 in a closed position;

FIG. 3 is a view of voltage to stationary wave of the prior art foldable mobile phone, which is used for explaining a detuning phenomenon of receiving and transmitting signals of the prior art foldable mobile phone under opened and closed positions;

FIG. 4 is an exploded view of a foldable wireless mobile phone according to a first preferred embodiment of the present invention, which shows an exploded view of a first circuit board and a second circuit board of the mobile phone, and the shapes of a shaft and an antenna portion;

FIG. 5 is a perspective view of the mobile phone of FIG. 4 wherein the first circuit board thereof is opened with respect to the second circuit board;

FIG. 6 is a shaft cross-sectional view of FIG. 4;

FIG. 7 is a perspective view of the mobile phone of FIG. 4 in the open position from another viewpoint;

FIG. 8 is perspective view of the first circuit board closing toward the second circuit board of the mobile phone in FIG. 4;

FIG. 9 is perspective view of a first coupling portion and a second coupling portion of the mobile phone in FIG. 4;

FIG. 10 is a perspective view of the first coupling portion and the second coupling portion of FIG. 9 in another state;

FIG. 11 is a view of voltage to stationary wave of the foldable mobile phone in FIG. 4, which is used for explaining the foldable mobile phone having the same function of receiving and transmitting signal under its open and closed positions;

FIG. 12 is an exploded view of a first circuit board closing toward a second circuit board of a foldable mobile phone according to a second embodiment of the present invention;

FIG. 13 is a shaft cross-sectional view of the foldable mobile phone of FIG. 12;

FIG. 14 is a perspective view of the mobile phone of FIG. 12 in the open position;

FIG. 15 is a perspective view of the mobile phone of FIG. 12 in the closed position;

FIG. 16 is an exploded view of a first circuit board closing toward a second circuit board of a foldable mobile phone according to a third embodiment of the present invention;

FIG. 17 is a perspective view of the mobile phone of FIG. 16 in the open position;

FIG. 18 is a perspective view of the mobile phone of FIG. 16 in the closed position;

FIG. 19 is an exploded view of a first circuit board closing toward a second circuit board of a foldable mobile phone according to a fourth embodiment of the present invention;

FIG. 20 is a shaft cross-sectional view of a foldable mobile phone of FIG. 19;

FIG. 21 is a perspective view of the mobile phone of FIG. 19 in the open position;

FIG. 22 is a perspective view of the mobile phone of FIG. 19 in the closed position.

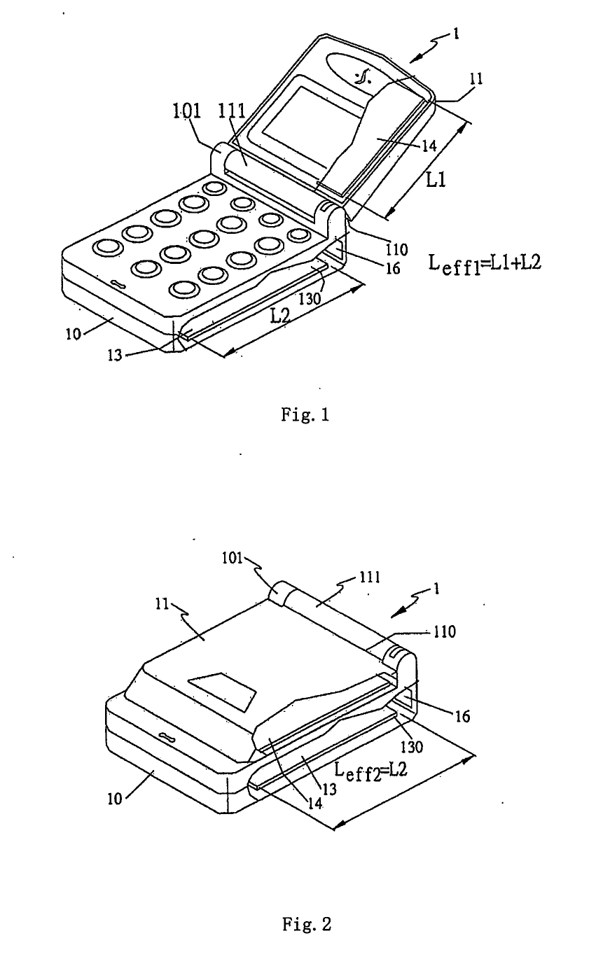

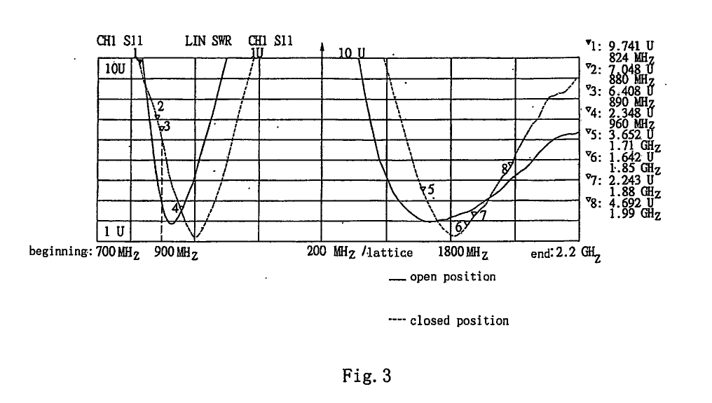

### DETAILED DESCRIPTION OF THE DISCLOSED EMBODIMENTS

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein.

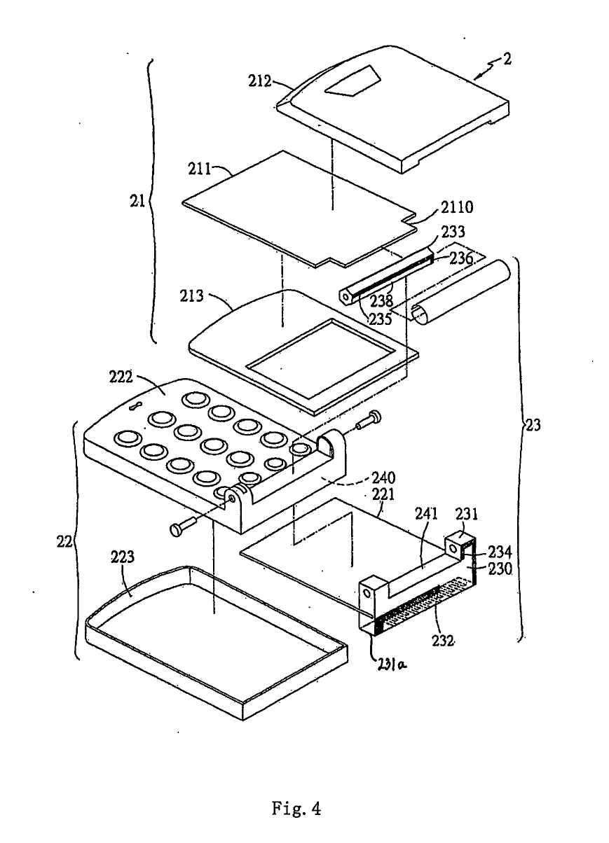

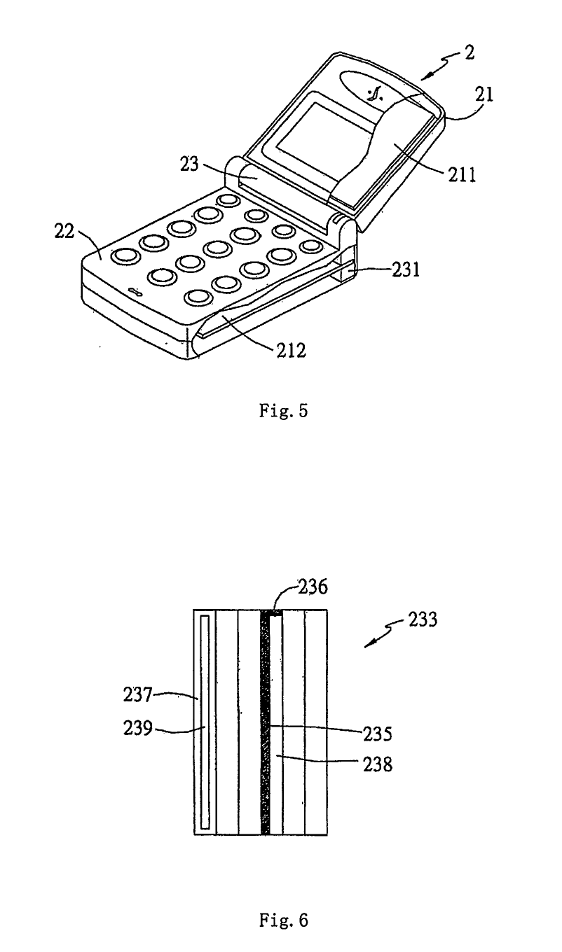

Referring to FIGS. 4 and 5, a preferred embodiment of the present invention is shown, and a foldable mobile phone (a mobile phone for short below) is used for an example in the present embodiment. The mobile phone 2 includes a first portion 21, a second portion 22 and a pivot member 23, and the first portion 21 is pivotally connected to the second portion 22 by the pivot member 23, such that the first portion 21 is pivotable with respect to the second portion 22 between an open position and a closed position.

The first portion 21 is a cover portion of the mobile phone 2, and includes a first circuit board 211, a top cover 212 located above the first circuit board 211 and for receiving the first circuit board 211, and a bottom cover 213 located below the first circuit board 211 and for closing with respect to the top cover 212 to limit the first circuit board 211 into the top cover 212.

The second portion 22 is a mainframe portion of the mobile phone, and includes a second circuit board 221, a top shell 222 enclosed above the second circuit board 221, and a bottom shell 223 located below the second circuit board 221 and for receiving the second circuit board 221 and mated with the top shell 222.

The pivot member 23 includes a base 231, an antenna portion 232 and a shaft 233. The base retains one end of the second circuit board 221. The base further defines a recess 241 downwardly formed by the top face of the base 231. Two ends of the recess 241 respectively have a shoulder. One end of the top shell 222 facing the base 231 defines a receiving space 240 for the base 231.

The antenna portion 232 according to the present embodiment is a double-frequency antenna, and is operatable at a frequency band between 900 MHZ and 1800 MHZ. The antenna portion 232 is bent at 90 degrees to wrap on the bottom face 231a of the base 231, and one end thereof is extended from the bottom face 231a of the base 231 toward adjacent side face 230 and to one end of the recess 241 and forms a first mated portion 234 on the one end of the recess 241.

The shaft 233 according to the present invention is a hexagonal cylinder, and two ends thereof are received into the recess 241 of the base 231 to pivot with the recess 241. Referring to FIG. 6, the shaft 233 has six rectangular side faces, and one side face 237 thereof defines an insertion slot 239 for receiving one end 2110 of the first circuit board 211, such that the first circuit board 211 is fixed to the shaft 233, while the other side face 238 of the shaft 233 forms a metal section 235, and a second mated portion 236 is formed at one end of the metal section 235 adjacent to the first mated portion 234, so that the side face 238 and the side face 230 of the base 231 are happenedly located on a same plane when the first portion 21 is pivoted to cover with the second portion 22.

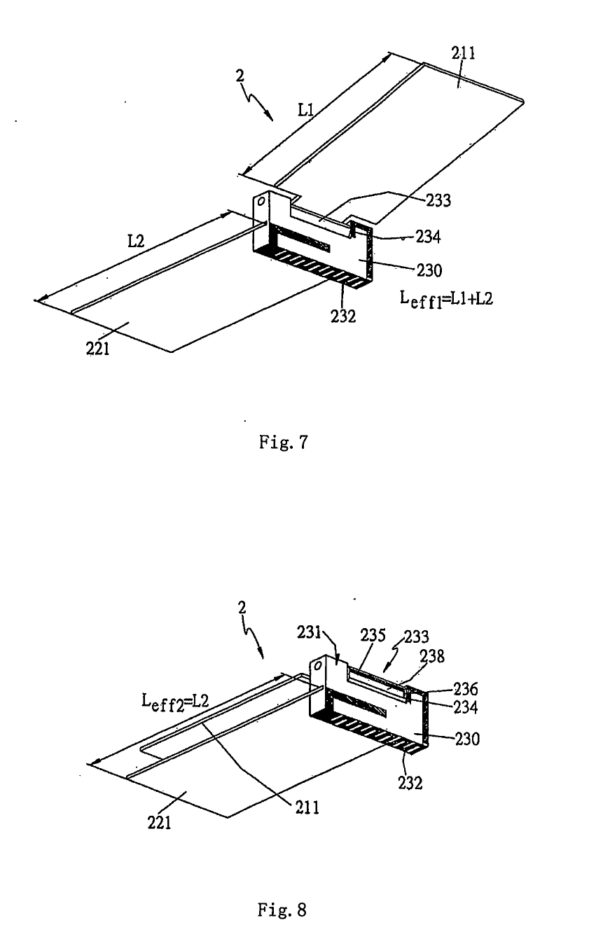

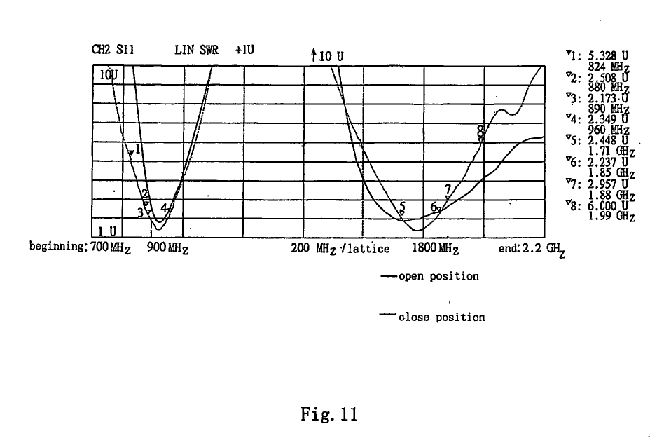

Referring to FIG. 7, simply considering the motion relations among the first circuit board 211, the pivot member 23 and the second circuit board 221, when the first circuit board 211 is opened in a direction far away from the second circuit board 221, because the shaft 233 is pivoted with the first circuit board 211, the side face 238 of the shaft 233 and the side face 232 of the recess 241 are not located on the same plane, meanwhile the metal section 235 is not adjacent to the antenna portion 232. Additionally, because the first circuit board 211 and the second circuit board 221 of the mobile phone 2 may provide an effective grounding length L_{eff1} for the antenna portion 232, the antenna portion 232 may exert a predetermined function of receiving and transmitting signal, and referring to FIG. 11, obtains a good effect of receiving and transmitting signal at a low frequency section (namely about 900 MHZ) and a high frequency section (namely about 1800 MHZ).

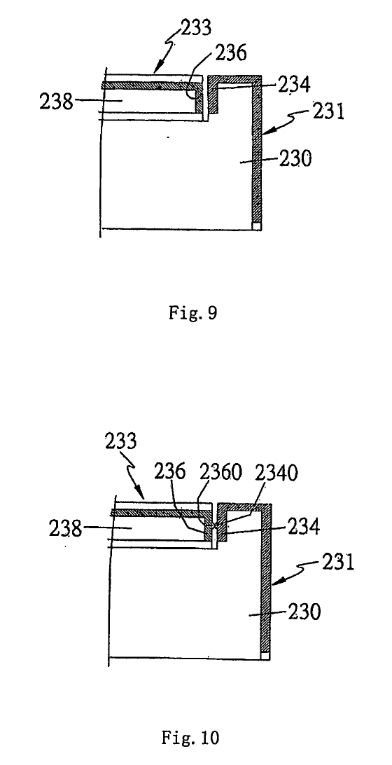

Next referring to FIG. 8, when the first circuit board 211 is closed toward the second circuit board 221, although the coupling effect produced by the superposition between the first circuit board 211 and the second circuit board 221 will reduce the effective grounding length L_{eff2} (produced by the first circuit board 211 and the second circuit board 221) of the antenna portion 232, the first mated portion 234 of the antenna portion 232 may face to the second mated portion 236 of the metal section 235 to get an electrical coupling therebetween, due to the side face 238 of the shaft 233 happenedly pivoted to locate on a same plane as the side face 230 of the base 231 at the same time. Furthermore, referring to FIG. 9, the electrical coupling according to the present invention is that the first mated portion 234 and the second mated portion 236 are face-to-face and are not contacted with each other (namely a space exists therebetween), replaced by a capacitance effect to produce the electrical coupling. Furthermore, referring to FIG. 10, the electrical coupling of the present embodiment may also be obtained by that the first mated portion 234 and the second mated portion 236 respectively outward form projected points 2340 and 2360, so that they produce an electrical connection by the projected points 2340 and 2360 contacting with each other.

Therefore, the electrical coupling between the metal section 235 and the antenna portion 232 makes the length of the antenna portion 232 increase to further overcome the above-mentioned problem of lacking the effective grounding length. Referring to FIG. 11, the mobile phone 2 even if at a closed position produces substantially the same receiving and transmitting effect at the low frequency section (namely about 900 MHZ) as it at the open position, thereby improving detuning phenomenon of the receiving and transmitting signal at the low frequency section of the mobile phone 2 under the closed position.

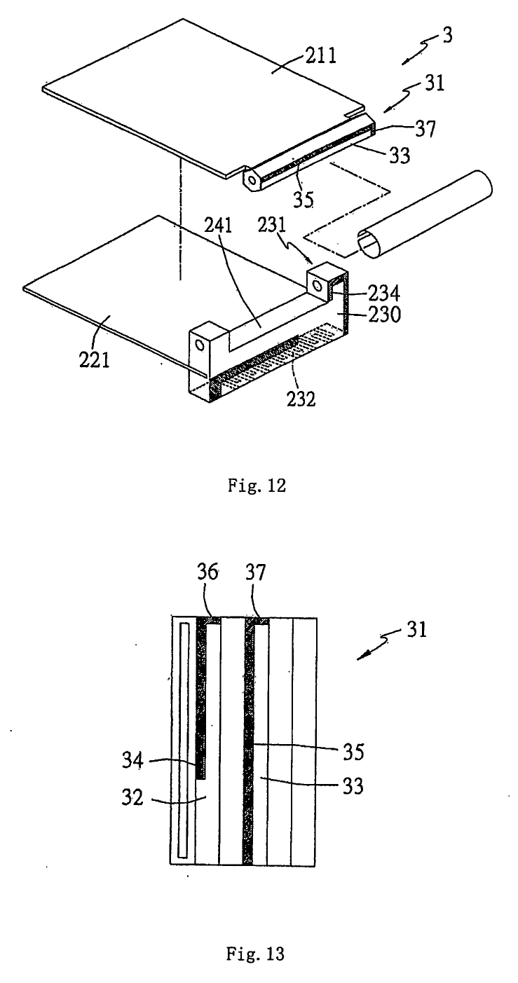

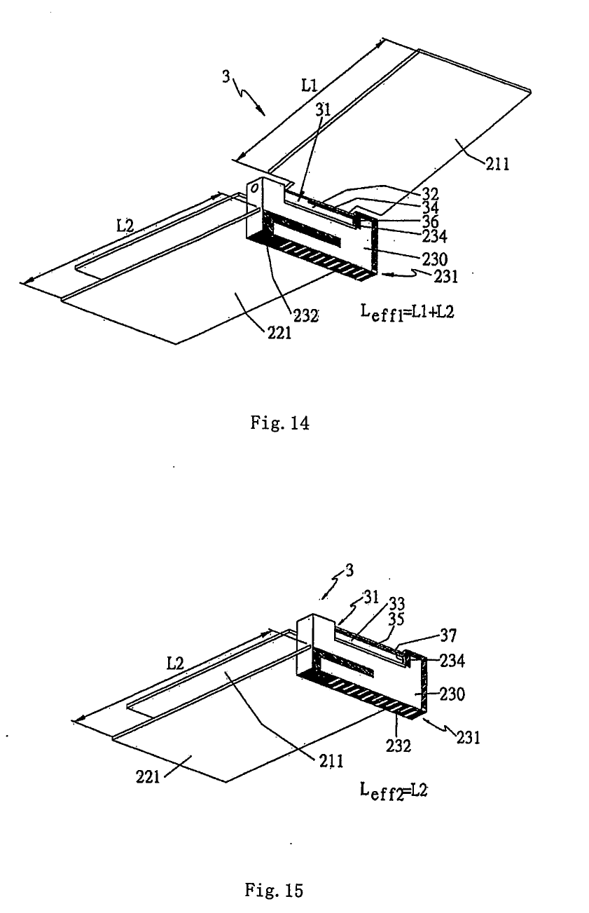

Next, referring to FIGS. 12 to 14, a second embodiment of the present invention is shown. Simply considering the constructions of the first circuit board 211, the pivot member 31 and the second circuit board 221, the foldable mobile phone of the present embodiment is different from the first embodiment in that the two non-adjacent side faces 32, 33 can also be provided with a first metal section 34 and a second metal section 35, respectively. Two ends of the two metal sections 34, 35 which are faced to the first coupling portion 234 of the base 231 respectively form a second coupling portion 36 and a second coupling portion 37. Accordingly, referring to FIG. 14, when the first circuit board 211 is opened away from the second circuit board 221, the first metal section 34 of the shaft 31 is faced to and electrically coupled to the first coupling portion 234 of the antenna portion 232 by the second coupling portion 36, thereby improving the receiving and transmitting effect of the antenna portion 232. Referring to FIG. 15, when the first circuit board 211 is closed toward the second circuit board 221, the second metal section 35 of the shaft 31 is faced to and electrically coupled to the first coupling portion 234 of the antenna portion 232 by the third coupling portion 37, thereby increasing the antenna length of the antenna portion 232 thereof by the second metal section 35 to further eliminate the detuning phenomenon of the receiving and transmitting signal at the low frequency under the closed position.

Therefore, as seen from the second embodiment, the metal section provided on the shaft 31 is not limited to only one face. Rather, the metal sections may be located on a plurality of metal sections according to the system requirements.

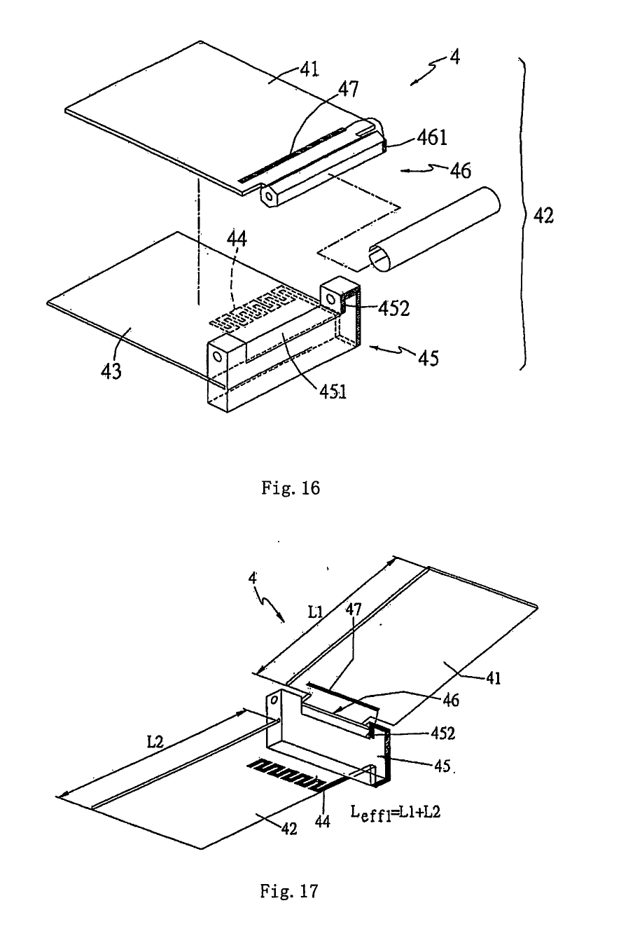

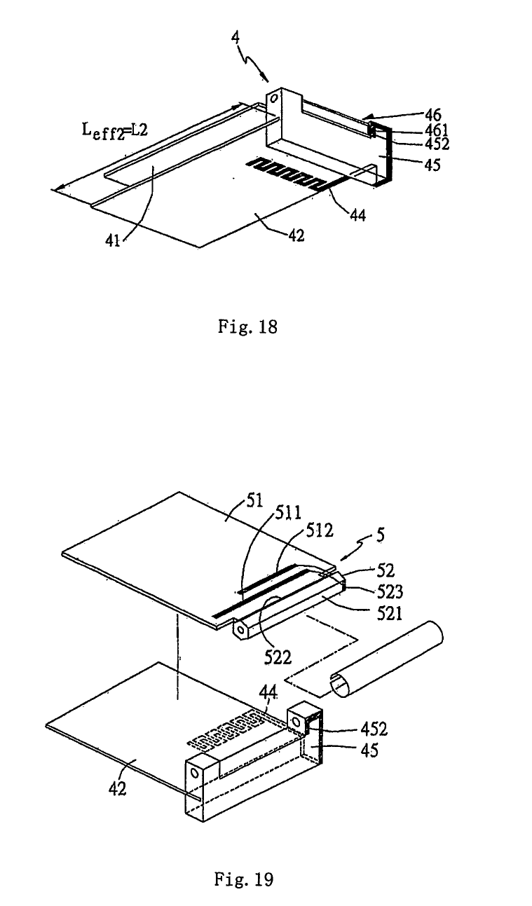

Further, referring to FIGS. 16 to 18, a third preferred embodiment of the present invention is shown therein. Simply considering the constructions of a first circuit board 41, a pivot member 42 (including a base 45 and a shaft 46) and a second circuit board 43, the foldable mobile phone 4 of the present embodiment is different from that of the first embodiment in that an antenna portion 44 is provided (or formed) on the back of the second circuit board 43, and one end of a recess 451 of a base 45 forms a first coupling portion 452. After the base 45 is fixed to the second circuit board 43, then one end of the antenna portion 44 is electrically connected to the first coupling portion 452 (i.e. by soldering or other routing ways). A metal section 47 is formed on the first circuit board 41, and one end of the shaft 46 facing the first coupling portion 452 forms a second coupling portion 461. After the first circuit board 41 is fixed to the shaft 46, then one end of the metal section 47 is electrically connected to the second coupling portion 461 (i.e. by soldering or other routing ways). Thereby, referring to FIG. 17, when the first circuit board 41 is opened in a direction away from the second circuit board 43, the first coupling portion 452 and the second coupling portion 461 are interlaced with each other and can not get an electrical coupling. While referring to FIG. 18, when the first circuit board 41 is closed toward the second circuit board 42, the antenna portion 44 gets an electrical coupling with the metal section 47 by the first coupling portion 452 and the second coupling portion 461 for eliminating the detuning phenomenon of the receiving and transmitting signal of the mobile phone 4 at the low frequency under the closed position.

Therefore, as seen from the third embodiment, the antenna portion 44 and the metal section 47 are not limited to be provided on the base 45 and the shaft 46, respectively, while they may be respectively provided on the first circuit board 41 and the second circuit board 43, or on other usable spaces of the electrical device.

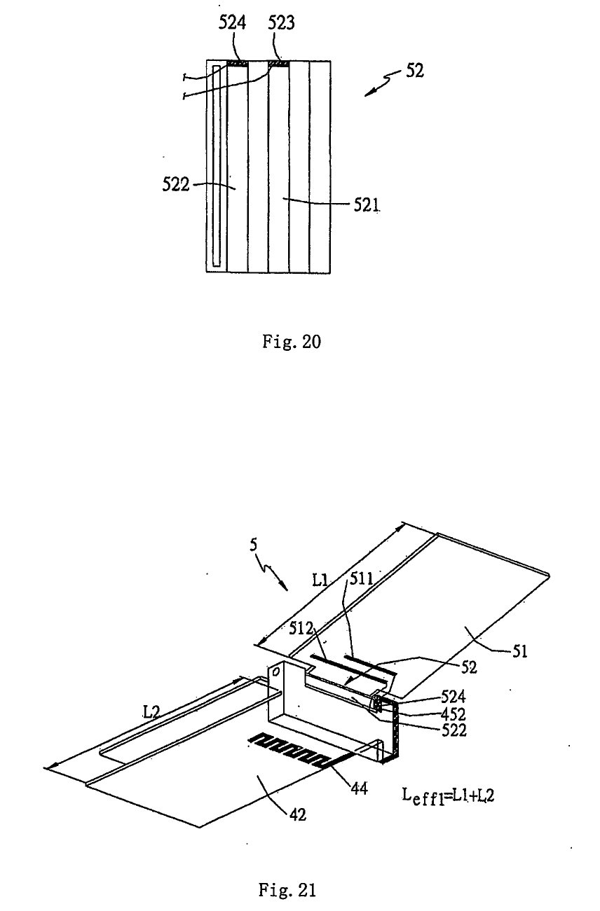

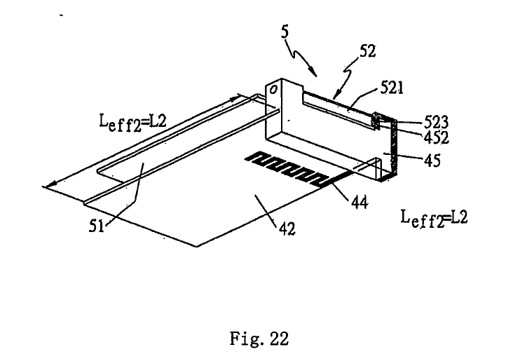

Further referring to FIGS. 19 to 22, a fourth preferred embodiment of the present invention is shown therein and is different from the third embodiment above in that a first circuit board 51 forms a first metal section 511 and a second metal section 512 with different lengths, and referring to FIG. 20, two ends of the two non-adjacent side faces 521, 522 of the shaft 52 thereof wherein the two ends are adjacent to the first coupling portion 452 of the base 45 respectively form a second coupling portion 523 and a third coupling portion 524. Referring to FIG. 21, when the first circuit board 51 is opened in a direction away from the second circuit board 42, the third coupling portion 524 of the shaft 52 and the first coupling portion are faced to each other and get an electrical coupling therebetween. Further referring to FIG. 22, when the first circuit board 51 is closed toward the second circuit board 42, the second coupling portion 523 of the shaft 52 and the first coupling portion 452 are faced to each other and get an electrical coupling therebetween. Thereby, the foldable mobile phone 5 under the opened or closed position is further improved the effect of receiving and transmitting signals thereof and eliminates the detuning phenomenon of the receiving and transmitting signal at the low frequency under the closed position by the antenna portion 42 respectively electrical coupling to the first and second metal sections 511, 512. Similarly, as seen from the fourth embodiment, the number of metal sections disposed on the first circuit board 51 may be increased according to the needs of the application.

All in all, the foldable wireless electrical device of the present invention forms the first coupling portion on the base of the pivot member, and forms a second coupling portion on a proper position of the shaft pivoted to the base, and the shaft may be directly formed on the first circuit board or be fixed to the first circuit board, the base may be directly formed on the second circuit board or be fixed to the second circuit board, and a metal section may be formed on the first circuit board or on the shaft and is electrically connected to the second coupling portion, furthermore, an antenna portion may be formed on the second circuit board or on the base and is electrically connected to the first coupling portion, which makes the antenna portion electrically coupled to the metal section by the first coupling portion and the second coupling portion when the first circuit board is pivoted to a predetermined position (i.e. the opened position or closed position above) with respect to the second circuit board so as to increase the antenna length of the antenna portion by metal sections. This results in compensating for the reduced grounding area of the mobile phone under the closed position to make the mobile phone 2 have the same effect of receiving and transmitting signal under the opened and closed positions to eliminate the detuning phenomenon of the antenna portion.

While the disclosed embodiments of the present invention are shown and described, it is envisioned that those skilled in the art may devise various modifications of the present invention without departing from the spirit and scope of the appended claims.

1. A foldable wireless electrical device, comprising:
a first portion;
a second portion, including an antenna portion; and
a shaft, extended between two adjacent ends of the first portion and the second portion, for pivotally connecting the first portion and the second portion such that the first and second sections can be pivoted to a closed position and to an open position, the shaft having a metal mating portion which electrically couples to the antenna portion when the first and second portions are pivoted to the closed position, and said metal mating portion electrically decoupling from said antenna portion when the first and second portions are pivoted to the open position.

2. (canceled)

3. The foldable wireless electrical device as claimed in claim 1, wherein the metal mating portion on the shaft forms a first metal section and the shaft further includes a second metal section spaced from the first metal section, wherein when the first and second portions are in the closed position, the antenna portion electrically couples to the first metal section, and when the first and second portions are in the open position, the antenna portion electrically couples to the second metal section.

4. The foldable wireless electrical device as claimed in claim 1, wherein the first portion includes a first circuit board, the second portion includes a second circuit board and a base fixed to one end of the second circuit board, a top face of the base defines a recess for receiving the shaft and pivotally connected to two ends of the shaft, and one end of the second circuit board is fixed to the shaft to make the first circuit board pivotable with respect to the second circuit board.

5. The foldable wireless electrical device as claimed in claim 4, wherein the antenna portion is routed on a surface of the base and one end thereof extends to one end of the recess to form a first coupling portion, and the metal mating portion extends along a length of the shaft, and one end thereof adjacent to the first coupling portion forms a second coupling portion, so as to make the first coupling portion move to a position facing to the second coupling portion for electrically coupling to the second coupling portion when the first portion is pivoted to the closed position.

6. The foldable wireless electrical device as claimed in claim 5, wherein when the first portion is pivoted to the closed position, a space exists between the first coupling portion and the second coupling portion, and forms a capacitive coupling to obtain an electrical coupling.

7. The foldable wireless electrical device as claimed in claim 5, wherein at least one projected point is respectively extended outward from at least one of the first coupling portion and the second coupling portion, so that when the first portion is pivoted to the closed position, the first coupling portion and the second coupling portion are electrically connected to each other by the projected point.

8. The foldable wireless electrical device as claimed in claim 1, wherein the foldable wireless electrical device is a foldable mobile phone.

9. A foldable wireless electrical device, comprising:
a first portion, including a metal section;
a second portion, including an antenna portion; and
a shaft, extended between two adjacent ends of the first portion and the second portion, for pivotally connecting the first portion and the second portion such that the first and second sections can be pivoted to a closed position and to an open position, the shaft forming a coupling portion, the metal section electrically coupling with the antenna portion by the coupling portion when the first and second portions are pivoted to the closed position and said metal section electrically decoupling with said antenna when the first and second portions are pivoted to the open position.

10. (canceled)

11. The foldable wireless electrical device as claimed in claim 9, wherein the first portion includes a first circuit board and the metal section is routed on the first circuit board, the second portion includes a second circuit board and a base fixed to one end of the second circuit board, the antenna portion is provided on the second circuit board, a top face of the base defines a recess for receiving the shaft and pivotally connected to two ends of the shaft, and one end of the first circuit board is fixed to the shaft to make the first circuit board be pivotable with respect to the second circuit board.

12. The foldable wireless electrical device as claimed in claim 11, wherein one end of the recess of the base forms a first coupling portion to electrically couple to the antenna portion, and one end of the shaft faced to the first coupling portion forms a second coupling portion, so that when the first circuit board pivots to the closed position, the first coupling portion and the second coupling portion are faced to each other and obtain an electrical coupling.

13. The foldable wireless electrical device as claimed in claim 12, wherein when the first circuit board is pivoted to the closed position, a space exists between the first coupling portion and the second coupling portion, and forms a capacitive coupling to obtain an electrically coupling.

14. The foldable wireless electrical device as claimed in claim 12, wherein at least one projected point is respectively extended outward from at least one of the first coupling portion and the second coupling portion, so that when the first circuit board is pivoted to the closed position, the first coupling portion and the second coupling portion are electrically 5 connected to each other by the projected point.

15. The foldable wireless electrical device as claimed in claim 11, wherein one end of the recess of the base forms a first coupling portion to electrically connect to the antenna portion, and the first circuit board forms a first metal section and a second metal section spaced from the first metal section, and the shaft forms a second coupling portion electrically connected to the first metal section and a third coupling portion spaced apart from the second coupling portion and electrically connected to the second metal section, so that when the first circuit board is pivoted to the open position, the first coupling portion and the second coupling portion are faced to each other and produce an electrical coupling, and when the first circuit board is pivoted to the closed position, the first coupling portion and the third coupling portion are faced to each other and produce an electrical coupling.

16. The foldable wireless electrical device as claimed in claim 15, wherein a space exists between the first coupling portion and the second coupling portion and the third coupling portion, and forms a capacitive coupling to obtain an electrical coupling.

17. The foldable wireless electrical device as claimed in claim 15, wherein at least one projected point is extended outward from at least one of the first coupling portion, the second coupling portion, and the third coupling portion, respectively, so that the first coupling portion, the second coupling portion and the third coupling portion are electrically connected to one other by the projected point.

18. The foldable wireless electrical device as claimed in claim 9, wherein the foldable wireless electrical device is a foldable mobile phone.

19-36. (canceled)

37. The foldable wireless electrical device as claimed in claim 1, wherein the antenna portion is a meander antenna portion positioned proximate said shaft.

38. The foldable wireless electrical device as claimed in claim 9, wherein the antenna portion is a meander antenna portion positioned proximate said shaft.
